(19) United States
(12) Patent Application Publication
(10) Pub. No.: US 2023/0089571 A1
(43) Pub. Date: Mar. 23, 2023

(54) METHOD AND APPARATUS FOR SUPPRESSING UNDESIRABLE TONES IN AN EXHAUST SYSTEM

(71) Applicant: TMG Performance Products, LLC, Berea, OH (US)

(72) Inventors: David T. NIKSA, Medina, OH (US); John D. HAMMETT, Lagrange, OH (US); Dennis L. HUFF, North Olmsted, OH (US)

(21) Appl. No.: 18/061,030

(22) Filed: Dec. 2, 2022

Related U.S. Application Data
(62) Division of application No. 16/568,674, filed on Sep. 12, 2019.
(60) Provisional application No. 62/730,034, filed on Sep. 12, 2018.

(51) Int. Cl. F01N 1/04; F16L 55/027; F01N 13/00; F16L 55/033

(52) U.S. Cl. CPC F01N 1/04; F16L 55/02745; F01N 13/011; F16L 55/0336

(57) ABSTRACT

Provided is a flow modification component for use with a muffler, which can be a Helmholtz resonator muffler, a side branch muffler, or a Y-pipe. The flow modification component includes a porous plate adapted for incorporation into a passage to a sound muffling portion connected to a through passage pipe of the muffler or Y-pipe. One or more openings are formed on the porous plate to allow low frequency acoustic waves to pass through into the passage to the sound muffling portion while reducing large-scale turbulent eddies that produce undesirable resonant tones within the aperture tube to small-scale turbulent eddies. The openings having sufficient porosity such that the resulting sound frequency is determined by size, shape, number, and spacing of the openings. The flow modification component can also include a dissipative material component in an internal port passage of the muffler to further reduce resonant tones.

This application is a divisional of, and claims priority to, U.S. Ser. No. 16/568,674, filed Sep. 12, 2019, which claims the benefit of U.S. Provisional Application No. 62/730,034, filed Sep. 12, 2018, which is fully incorporated herein by reference.

### I. BACKGROUND

### A. Technical Field

This invention pertains to the field of mufflers for use with a vehicle exhaust system to suppress noise generated by an internal combustion engine. This invention pertains particularly to the field of suppressing noise generated by resonant frequencies within a muffler used with a vehicle.

### B. Description of Related Art

Exhaust gases from internal combustion engines require mufflers to suppress noise. Certain mufflers and pipes, while effective at reducing the overall sound level, can produce undesirable noise in the form of unwanted tones as a result of resonance in the pipes caused by a certain flow rate of exhaust gases through the pipes. Helmholtz resonator mufflers, side branch resonator mufflers, and Y-pipe mufflers are a common type of mufflers used on automobiles. But under certain flow conditions in these types of mufflers, unwanted tones are also produced by flow over an opening to a diverging pipe used in these designs, similar to the classical demonstration of a blowing air over the lip of a bottle. Flow conditions can be found in exhaust pipes of all types where large-scale turbulent eddies cause undesirable tones due to coupling with resonant acoustic modes of the exhaust system.

A standard-type Helmholtz resonator muffler is shown in FIG. 1 which depicts a muffler 10 having an inlet 12 and an outlet 14 joined by a through passage pipe 16. The inlet 12 passes through an end enclosure 26 and the outlet 14 passes through an outlet end enclosure 28. An aperture tube 32 allows gases to pass radially outward through the pipe 16 into a confined space 22. A single aperture tube 32 is depicted, though a plurality of aperture tubes 32 can alternatively be employed in a specific muffler design.

The outer diameter of the end enclosure 26 is defined by an outer shell 24 forming a confined space 22 with end enclosures 26, 28. The confined space 22 is also known as the “tank” and can be of any suitably effective size and shape. The aperture tube or “neck” 32 typically has a variable length L and a cross-sectional area A allowing gases to pass between the through passage pipe 16 and the confined space 22. The volume of the confined space 22 is also typically varied. Installation of this muffler in an exhaust system is known to produce resonant tones or “whistles” under certain flow conditions.

A typical example of a side branch resonator muffler is shown in FIG. 2, which depicts an inlet 12 and an outlet 14 joined by a through passage pipe 16. A side branch passage 52 allows incident sound waves to pass radially outward from the pipe 16, into the side branch passage 52, and reflected from surface 54 back through the side branch passage 52 and into the through passage pipe 16. A single side branch passage 52 is depicted, though a plurality of side branch passages 52 can alternatively be employed. The reflected acoustic waves are 180 degrees out of phase from the incident acoustic waves. The side branch passage 52 has variable length L to control the frequency of the quarter-wave resonator, and cross-sectional area A to control the amplitude of sound reduction.

In another example shown in FIG. 3, other flow conditions can be found in exhaust pipes where the flow is split through a “Y-Pipe.” A common Y-pipe muffler design used in exhaust systems splits the flow from one pipe into two or more pipes. An inlet 60 and outlets 70 and 72 are joined by a primary through passage pipe 62 that splits into secondary through passage pipes 66, 68. A split junction 64 separates flow from the primary through passage pipe 62 to the secondary through passage pipes 70, 72. Under certain flow conditions, this configuration also produces resonant tones or whistles. Large scale turbulent eddies cause resonant tones due to flow separation at the split junction 64 and acoustic interaction with the pipe surfaces.

### II. Summary

Provided in this disclosure is a muffler having an internal geometry for suppressing the tones of resonant frequencies associated with flow noise from exhaust pipes. The muffler includes a flow modification component mounted flush to the primary flow path in the exhaust pipe and contains openings such as slots that modify the secondary flow entering the muffler through an aperture tube. The slots in the flow modification component modifies the flow to thereby allow acoustic waves to pass through the device to maintain the effectiveness of the muffler while suppressing tones that are produced in the absence of the slots.

To that end, an exemplary embodiment of the present invention includes a muffler including a through passage pipe with an inlet for admitting a flow of exhaust gases. A diverging pipe branches off from the through passage pipe. A flow modification component is incorporated into one of the diverging pipe or the through passage pipe at a position proximate to a junction of the through passage pipe and the diverging pipe. The flow modification component includes at least one structure that allows low frequency acoustic waves to pass through while reducing large-scale turbulent eddies that produce undesirable resonant tones to small-scale turbulent eddies.

In one aspect of the invention, the flow modification component is incorporated into an opening in the diverging pipe at a position proximate to the junction of the through passage pipe and the diverging pipe and flush to the through passage pipe. The at least one structure of the flow modification component includes a porous plate having a screen pattern geometry in the form of a plurality of openings having sufficient porosity to allow the low frequency acoustic waves to pass through while reducing the large-scale turbulent eddies to the small-scale turbulent eddies that will not acoustically couple with acoustic resonant modes of the muffler.

The screen pattern geometry of the porous plate includes a predetermined size, shape, number, and spacing of the plurality of openings, such that a frequency of sound from the small-scale turbulent eddies is determined by the screen pattern geometry. The plurality of openings can include at least one of holes, slits, or slots. The screen pattern comprises a plurality of openings having at least 20% open porosity or at least 60% open porosity.

In another aspect of the invention, the at least one structure of the flow modification component can include a dissipative material component retained within an internal port passage of the diverging pipe tube to further reduce resonant tones of the muffler. The dissipative material component comprises loosely packed fiber material having a material density selected to allow low frequency acoustic sound waves to be transmitted while attenuating higher frequency sound waves. The dissipative material component is substantially transparent to low frequency sound waves below about 1000 Hz.

In yet another aspect of the invention, the flow modification component can be incorporated into the through passage pipe at a position proximate to the junction of the through passage pipe and the diverging pipe. The at least one structure of the flow modification component includes at least one lobe incorporated into the through passage pipe at a position just upstream of the diverging pipe, at the position proximate to the junction of the through passage pipe and the diverging pipe. The lobe can penetrate into the through passage pipe less than 50% of the inside diameter of the through passage pipe.

In still another aspect of the invention, the through passage pipe also includes an outlet such that the through passage pipe joins the inlet and the outlet. The muffler can be a Helmholtz resonator muffler such that the inlet passes through an inlet end enclosure and the outlet passes through an outlet end enclosure. An outer shell defines an outer surface of an enclosed body of the muffler and forms a confined space between the end enclosures. The diverging pipe is an aperture tube, connected to the through passage pipe, to allow exhaust gases to pass outward from the through passage pipe into the confined space for sound suppression.

In an alternative embodiment of the invention, the muffler can be a side branch resonator muffler. The diverging pipe is a side branch passage connected to the through passage pipe enabling incident acoustic waves to pass outward from the through passage pipe and reflect from a back surface such that reflected acoustic waves are 180 degrees out of phase from the incident acoustic waves.

In a further alternative embodiment of the invention, the muffler can be a Y-pipe muffler such that the through passage pipe is a primary through passage pipe that joins a pair of secondary through passage pipes at a split junction. The diverging pipe is one of the secondary through passage pipes.

According to one aspect of the invention, the flow modification component in a Helmholtz muffler reduces resonance over an aperture tube, thereby suppressing resonant tones.

According to another aspect of the invention, the flow modification component in a muffler having a side branch resonator reduces resonance over a side branch passage, thereby suppressing resonant tones.

According to yet another aspect of the invention, the flow modification component in muffler having a Y-pipe reduces resonance over a side branch passage, thereby suppressing resonant tones.

According to a further aspect of the invention, the flow modification component can be a screen or plate retained in an adjoining passage of an exhaust pipe, the screen or plate having a plurality of openings with selected shapes and sizes to reduce the large-scale turbulent eddies that produce the resonant tones into small-scale eddies that do not produce the resonant tones.

According to another further aspect of the invention, the flow modification component can include a dissipative material component retained in an adjoining passage of an exhaust pipe to reduce the large-scale turbulent eddies that produce the resonant tones into small-scale eddies that do not produce the resonant tones.

According to yet another further aspect of the invention, the flow modification component can include one or more lobes that penetrate the flow inside an exhaust pipe to reduce the large-scale turbulent eddies that produce the resonant tones into small-scale eddies that do not produce the resonant tones.

Other benefits and advantages of this invention will become apparent to those skilled in the art to which it pertains upon reading and understanding of the following detailed specification.

### III. Brief Description of the Drawings

The disclosed muffler may take physical form in certain parts and arrangement of parts, embodiments of which will be described in detail in this specification and illustrated in the accompanying drawings which form a part hereof and wherein:

FIG. 1 is a side-sectional view of a standard-type Helmholtz resonator muffler;

FIG. 2 is a side-sectional view of a typical muffler with a side branch resonator;

FIG. 3 is a side-sectional view of a common-type muffler with a Y-pipe;

FIG. 4 is a side-sectional view of a Helmholtz resonator muffler having a flow modification component in accordance with an exemplary embodiment of the present invention;

FIG. 5 is an overhead view showing a variety of different types of flow modification components in accordance with exemplary embodiments of the present invention;

FIG. 6 is a side-sectional view of a Helmholtz resonator muffler having a flow modification component in accordance with an exemplary embodiment of the present invention;

FIG. 7 is a side-sectional view of a muffler with a side branch resonator having a flow modification component in accordance with an alternate exemplary embodiment of the present invention;

FIG. 8 is a side-sectional view of a muffler with a Y-pipe having a flow modification component in accordance with a further alternate exemplary embodiment of the present invention;

FIG. 9 is a side-sectional view of a Helmholtz resonator muffler having a flow modification component in the form of at least one lobe in accordance with an additional exemplary embodiment of the present invention;

FIG. 10 is a cross-sectional view taken along line A-A shown in FIG. 9 depicting of a Helmholtz resonator muffler having a flow modification component in the form of at one lobe in accordance with a further additional exemplary embodiment of the present invention;

FIG. 11 is a side-sectional view of a muffler with a Y-pipe having a flow modification component in the form of at least one lobe in accordance with another additional exemplary embodiment of the present invention;

FIG. 12 is a graph depicting sound pressure level in decibels versus frequency of acoustic spectra for a Helmholtz resonator muffler, comparing the outputs with and without the flow modification component in accordance with an exemplary embodiment of the present invention;

FIG. 13 is a graph depicting level amplitude versus linear frequency of acoustic spectra for a side branch resonator muffler, comparing with and without the flow modification component in accordance with another exemplary embodiment of the present invention;

FIG. 14 is a graph depicting sounds pressure level in decibels versus linear frequency of acoustic spectra for a Helmholtz resonator muffler, comparing the outputs without a flow modification component, with a one lobe, and with a screen with slots, in accordance with yet another exemplary embodiment of the present invention;

FIG. 15 is a cross-sectional view taken along line A-A shown in FIG. 9 depicting a Helmholtz resonator muffler having a flow modification component in the form of protrusions and chevrons in accordance with additional alternative exemplary embodiments of the present invention;

FIG. 16 is a perspective view depicting a Helmholtz resonator muffler having a flow modification component in the form of protrusions and chevrons in accordance with an additional alternative exemplary embodiment of the present invention; and

FIG. 17 is a side-sectional view of a muffler with a side branch resonator having a flow modification component in the form of various pipe modifications in accordance with additional exemplary embodiments of the present invention.

### IV. DETAILED DESCRIPTION

Referring now to the drawings wherein the showings are for purposes of illustrating embodiments of the article only and not for purposes of limiting the same, and wherein like reference numerals are understood to refer to like components.

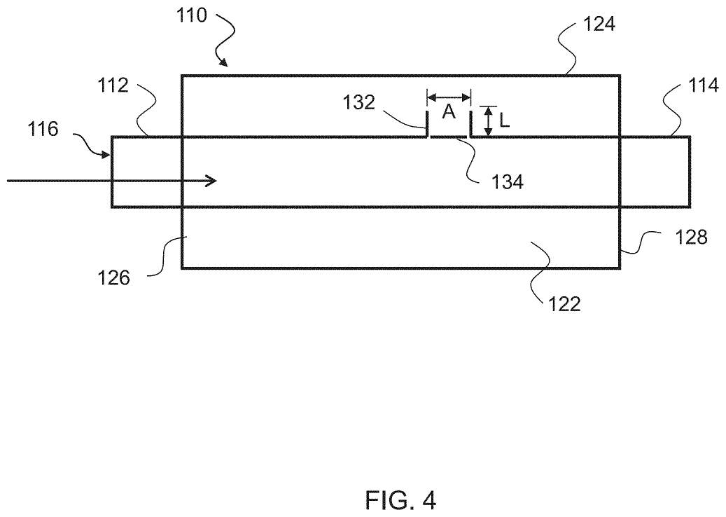

A Helmholtz resonator muffler in accordance with an exemplary embodiment of the present invention is shown in FIG. 4, depicting a muffler 110 having an inlet 112 and an outlet 114 joined by a through passage pipe 116. It is to be appreciated that the inlet 112 receives a flow of exhaust gases, which travel along the through passage pipe 116 and exit the outlet 114. The inlet 112 passes through an inlet end enclosure 126 and the outlet 114 passes through an outlet end enclosure 128. An aperture tube 132 allows gases to pass radially outward through the through passage pipe 116 into a confined space 122. The aperture tube 132 is generally a diverging pipe that branches off from the through passage pipe 116. A single aperture tube 132 is depicted, though a plurality of aperture tubes 132 can alternatively be employed.

The outer surface of the enclosed body of the muffler 110 is defined by an outer shell 124 forming a confined space 122 between the end enclosures 126, 128. The confined space 122 is also known as the “tank” and can be of any suitable shape. The aperture tube 132 is also known as the “neck” and can have a variable length L and a cross-sectional area A allowing gases to pass between the through passage pipe 116 and the confined space 122.

As further shown in FIG. 4, a flow modification component is incorporated into an opening in the aperture tube 132 at a position proximate to the junction of the through passage pipe 116 and the aperture tube 132 and flush to the through passage pipe 116. The flow modification device can be embodied as a porous plate 134 having a screen geometry in the form of one or more openings of sufficient porosity to allow low frequency acoustic waves to pass through the porous plate 134 while reducing the large-scale turbulent eddies within the aperture tube 132 to small-scale turbulent eddies. The frequency of the sound from the small-scale turbulent eddies is controlled by the size, shape, number, and spacing of the openings in the screen of the porous plate 134.

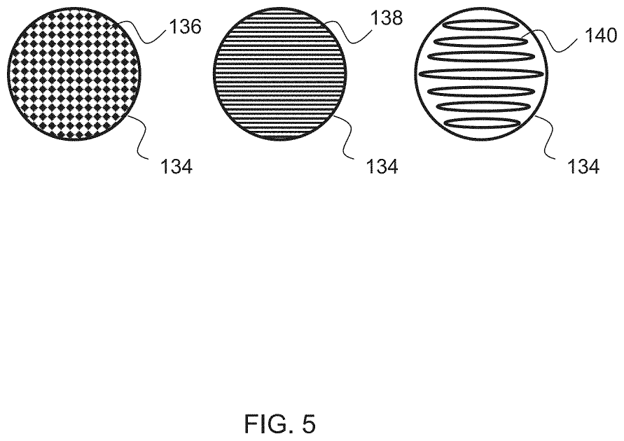

Exemplary embodiments of various screen patterns of the porous plate 134 are shown in FIG. 5. It is to be appreciated that the overhead views depicted in FIG. 5 face the direction of flow through the porous plate 134, as it is received in the aperture tube 132, perpendicular to the direction of flow of gases within the through passage pipe 116. The screen patterns can optionally include holes 136, slits 138, slots 140, or any other suitable pattern that reduces large-scale turbulent eddies into small-scale eddies. However, it is to be appreciated that the screen patterns of the porous plate 134 are not restricted to only the patterns depicted in FIG. 5.

In further exemplary embodiments, the porous plate 134 can include a screen pattern having holes, slits, and/or slots between 5% and 90% open porosity. Desirable sound suppression results can be obtained using a porous plate 134 with a screen pattern having holes, slits, and/or slots with a lower bound of at least 20% open porosity. In further additional exemplary embodiments, the porous plate 134 can also provide desirable results using a screen pattern with holes, slits, and/or slots with an upper bound of at least 60% open porosity.

Any suitable screen pattern geometry including any sort sizes and shapes of openings, ports, or cavities or any suitable combination of the aforementioned shapes and sizes thereof can be contemplated without departing from the invention. Any type of screen pattern geometry can be designed such that the small-scale eddies at one or more selected flow velocities will not acoustically couple with the acoustic resonant modes of the exhaust system that could produce undesirable tones or whistles.

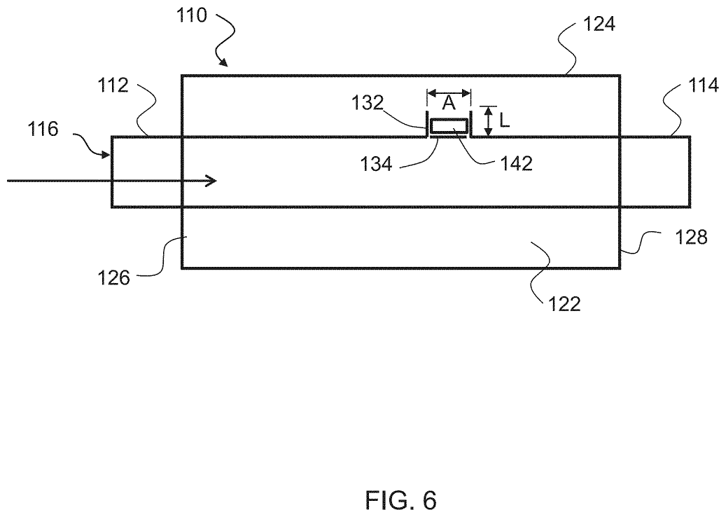

In another embodiment of the invention shown in FIG. 6, the flow modification component can include a dissipative material component 142 that reduces resonant tones resulting from the insertion of the muffler 110 into an exhaust system. As shown in the figure, a muffler 110 has an inlet 112 and an outlet 114 that are joined by a through passage pipe 116. The inlet 112 passes through an inlet end enclosure 126 and the outlet 114 passes through an outlet end enclosure 128. An aperture tube 132 allows gases to pass radially outward through the pipe 116 into a confined space 122. A single aperture tube 132 is depicted, though a plurality of aperture tubes 132 can alternatively be employed.

The outer surface of the enclosed body of the muffler 110 is defined by an outer shell 124 forming a confined space 122 between the end enclosures 126, 128. The confined space 122 is also known as the “tank” and can be of any suitable shape. The aperture tube 132 is also known as the “neck” and can have a variable length L and a cross-sectional area A allowing gases to pass from the through passage pipe 116 to the confined space 122.

The dissipative material component 142 is incorporated to an internal port passage at the opening of the aperture tube 132 at a position proximate to the junction of the through passage pipe 116 and the aperture tube 132 and flush to the through passage pipe 116. The dissipative material component 142 can be incorporated in combination with the porous plate 134, as shown in FIG. 6, or it can instead be incorporated alone.

The dissipative material component 142 can be made from loosely packed fiber material having a material density selected to allow low frequency acoustic sound waves to be transmitted through the dissipative material component 142 while attenuating higher frequency sound waves. In an exemplary preferred embodiment, the dissipative material layer is substantially transparent to low frequency sound waves below about 1000 Hz. The dissipative material component 142 can also be made from other porous materials such as metal or ceramic foams.

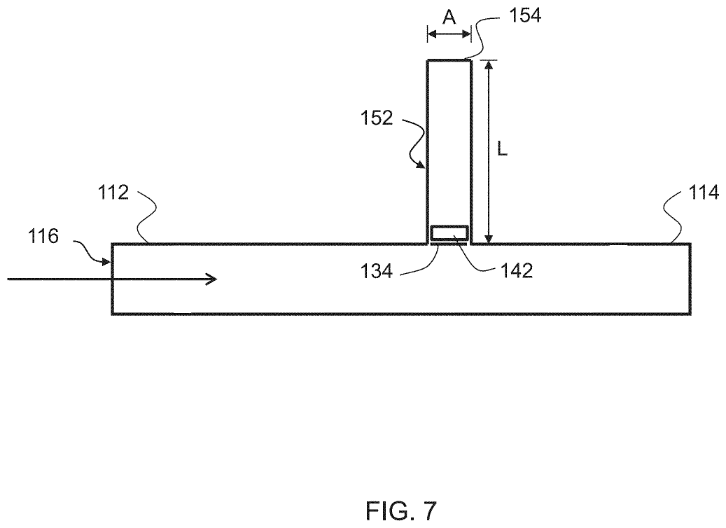

In yet another embodiment of the invention shown in FIG. 7, a flow modification component in the form of a porous plate 134 can be added to a side branch resonator muffler. An inlet 112 and an outlet 114 are joined by a through passage pipe 116. A side branch passage 152 allows incident sound waves to pass radially outward from the pipe 116, into the side branch passage 152, and reflected from the surface 154 back through the side branch passage 152 and into the through passage pipe 116. The reflected acoustic waves are 180 degrees out of phase from the incident acoustic waves.

Like the aperture tube 132 in the aforementioned embodiment, the side branch passage 152 is generally a diverging pipe that branches off from the through passage pipe 116. A single side branch passage 152 is depicted, though a plurality of side branch passages 152 can alternatively be employed. The side branch passage 152 has variable length L to control the frequency of the quarter-wave resonator, and cross-sectional area A to control the amplitude of sound reduction.

The flow modification component is incorporated into the side branch passage 152 of the side branch resonator to reduce resonant tones resulting from the insertion of the side branch resonator into an exhaust system. The flow modification component is incorporated into an opening in the side branch passage 152 at a position proximate to the junction of the through passage pipe 116 and the side branch passage 152 and flush to the through passage pipe 116.

The flow modification component can be embodied as a porous plate 134 having a screen pattern with sufficient porosity to allow low frequency acoustic waves to pass through the porous plate 134 while reducing the large-scale turbulent eddies within the side branch passage 152 to small-scale turbulent eddies. The frequency of the sound from the small-scale turbulent eddies is controlled by the size of the holes in the porous plate 134.

As with the aforementioned embodiments, exemplary embodiments of various screen patterns of the porous plate 134 are shown in FIG. 5. However, it is to be appreciated that the screen patterns of the porous plate 134 are not restricted to only the patterns depicted in FIG. 5. The screen patterns can optionally include holes 136, slits 138, slots 140, or any other suitable pattern that reduces large-scale turbulent eddies into small-scale eddies.

As further shown in FIG. 7, in addition to the porous plate 134, a dissipative material component 142 can be additionally or alternatively added within the side branch passage 152 of the side branch resonator to further reduce resonant tones resulting from the insertion of the side branch resonator into an exhaust system.

As with the aforementioned embodiments, the dissipative material component 142 can be added within the side branch passage 152. The dissipative material component 142 can be made from loosely packed fiber material that is retained by the flow modification component 134. The material density is selected to allow low frequency acoustic sound waves to be transmitted through the dissipative material component 142 while attenuating higher frequency sound waves. The dissipative material component 142 can be made from other porous materials such as metal or ceramic foams.

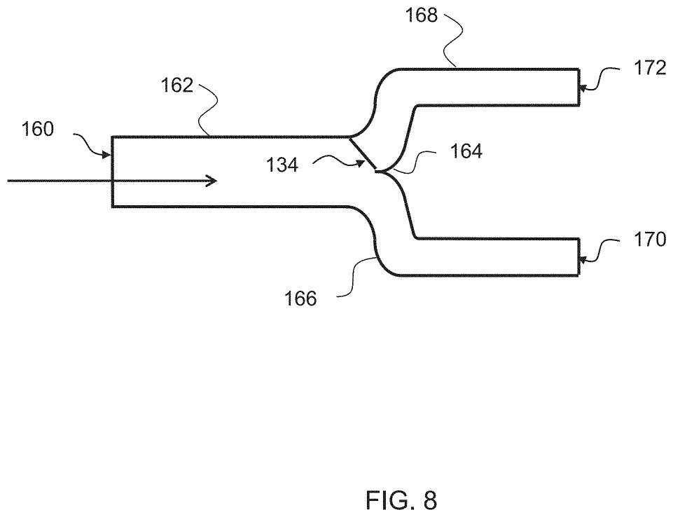

In yet another embodiment of the invention shown in FIG. 8, a flow modification component can be added to a Y-pipe muffler to reduce resonant tones associated with flow split junctions that produce turbulent flow. A single inlet 160 and a pair of outlets 170, 172 are joined by a primary through passage pipe 162 and a pair of secondary through passage pipes 166, 168. A split junction 164 separates flow from the primary through passage pipe 162 to the secondary through passage pipes 166, 168. The secondary through passage pipes 166, 168 are generally diverging pipes that branch off from the primary through passage pipe 162.

A flow modification device in the form of a porous plate 134 is added to either of the two secondary through passage pipes 166, 168, as shown in FIG. 8. The flow modification component is incorporated into an opening in the selected one of the two secondary through passage pipes 166, 168 at a position proximate to the split junction 164 of the primary through passage pipe 162 and the selected one of the two secondary through passage pipes 166, 168, and flush to the primary through passage pipe 162.

As depicted in FIG. 8, the porous plate 134 can have a screen pattern geometry with sufficient porosity to allow specific exhaust flow into the selected secondary through passage pipe 168 while reducing the large-scale turbulent eddies within the split junction 164 to small scale turbulent eddies. The frequency of the sound from the small-scale turbulent eddies is controlled by the size of the openings in the flow modification device 134. As with the other exemplary embodiments, examples of porous plates 134 are shown but not restricted to the patterns depicted in FIG. 5. The screen can include of holes 136, slits 138, slots 140, or any other suitable pattern that reduces large scale turbulent eddies into small scale eddies.

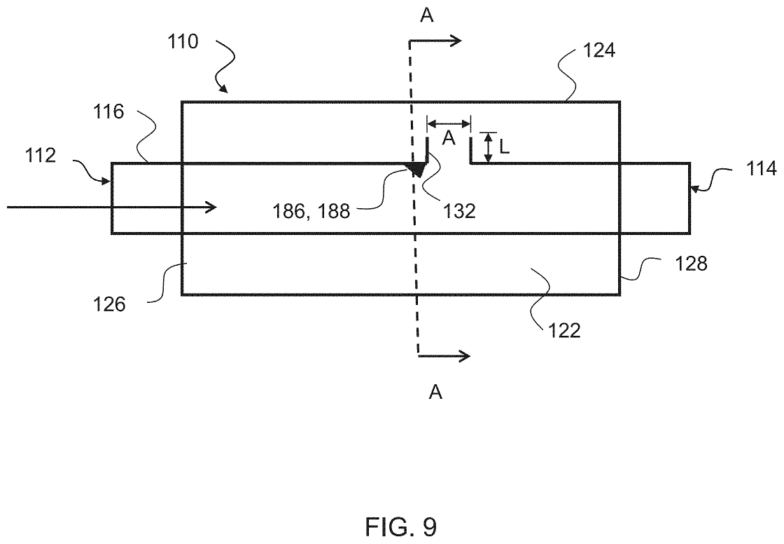

Yet another embodiment of the invention shown in FIG. 9 modifies the turbulent flow with a flow modification device in the form of one or more lobes 186, 188 located just upstream of the muffler aperture tube 132 in a Helmholtz resonator muffler 110. A single lobe 186 can be employed, though a plurality of lobes 186, 188 can alternatively be employed, as explained in greater detail hereinbelow. FIG. 9 depicts a muffler 110 having an inlet 112 and an outlet 114 joined by a through passage pipe 116. The inlet 112 passes through an inlet end enclosure 126 and the outlet 114 passes through an outlet end enclosure 128. An aperture tube 132 allows gases to pass radially outward through the pipe 116 into a confined space 122. A single aperture tube 132 is depicted, though a plurality of aperture tubes 132 can alternatively be employed.

The outer surface of the enclosed body of the muffler 110 is defined by an outer shell 124 forming a confined space 122 with end enclosures 126, 128. The shape of the confined space 122 is also called a “tank” and can be of any suitable shape. The aperture tube or “neck” 132 has a variable length L and a cross-sectional area A allowing gases to pass between the through passage pipe 116 and the confined space 122.

The flow modification component in the form of one or more lobes 186, 188 are incorporated into the through passage pipe 116 at a position located just upstream of the aperture tube 132, at a position proximate to the junction of the through passage pipe 116 and the aperture tube 132 and flush to the through passage pipe 116. The lobes 186, 188 modify the turbulent flow within the through passage pipe 116 to suppress tones.

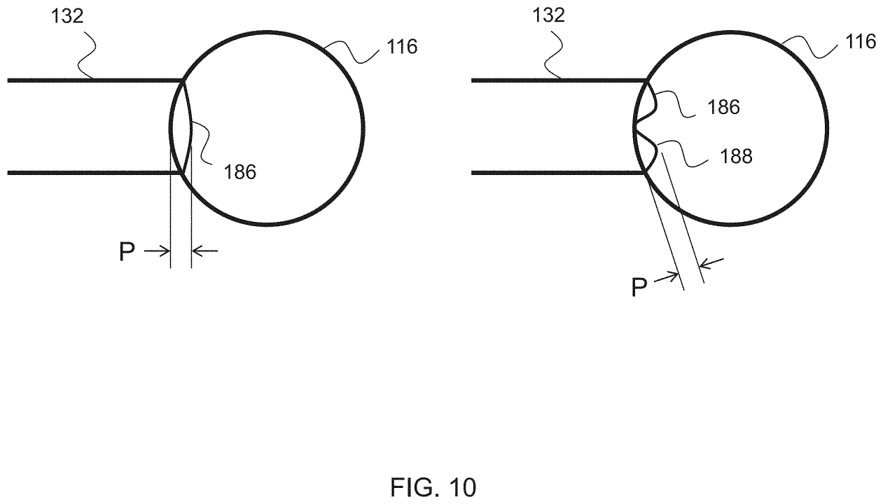

The lobes 186, 188 are further illustrated in FIG. 10, which is a cross-sectional view taken along the line A-A indicated in FIG. 9. FIG. 10 shows the penetration P of a single lobe 186 or the multiple lobes 186, 188 into the cross-sectional diameter of the through passage pipe 116. The one or more lobes 186, 188 disrupt the large-scale turbulent eddies along the aperture tube 132, and thereby alter the resonance that produce the unwanted tones.

The extent of the penetration P can be varied to control the turbulent length scales responsible for the generation of the tones. As shown in FIG. 10, a single lobe 186 located just upstream of a muffler aperture tube 132 in the direction of flow of exhaust gases in the through passage pipe 116 of a muffler. A penetration P into the through passage pipe 116 less than 25% of the inside diameter of the through passage pipe 116 had been found to be effective at reducing the unwanted tones. Similar results have been obtained with multiple lobes 186, 188 located just upstream of a muffler aperture tube 132 with a penetration P of less than 25% into the inside diameter of the exhaust pipe, as also shown in FIG. 10.

It should be appreciated that a flow modification component in the form of one or more lobes 186, 188 can also be incorporated into a through passage pipe 116 of a side branch resonator embodiment, as described hereinabove, and located at a position located just upstream of a side branch passage 152, at a position proximate to the junction of the through passage pipe 116 and the side branch passage 152 and flush to the through passage pipe 116. The lobes 186, 188 modify the turbulent flow within the through passage pipe 116 to suppress tones.

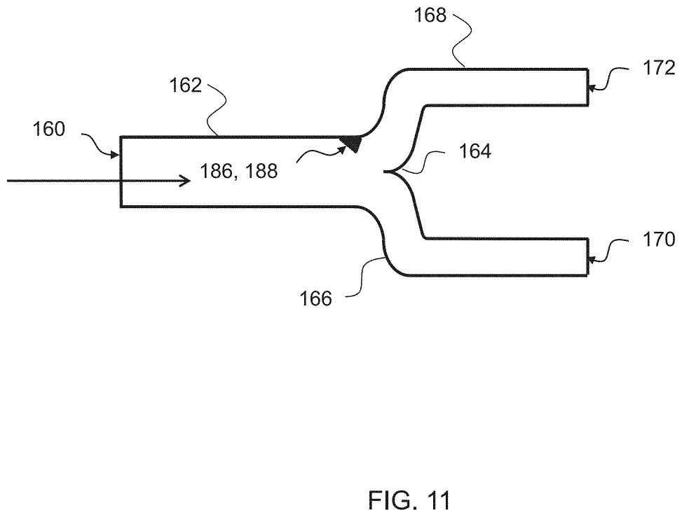

Yet another embodiment of the invention is shown in FIG. 11 including a flow modification component in the form of one or more lobes 186, 188 for use with a split junction 164. As shown, an inlet 160 and outlets 170, 172 are joined by a primary through passage pipe 162 and secondary through passage pipes 166, 168. A split junction 164 separates the flow from the primary though passage pipe 162 to the secondary through passage pipes 166, 168.

A flow modification component in the form of one or more lobes 186, 188 are incorporated into the through passage pipe 116 at a position located just upstream of the split junction 164 at a position proximate to the split junction 164 to modify the turbulent flow within a respective one of the secondary through passage pipes 166, 168 to suppress tones. As with the previously described embodiment, the lobes 186, 188 are further illustrated in the cross-sectional view of FIG. 10 which shows the penetration P of a single lobe 186 or the multiple lobes 186, 188 into the cross-sectional diameter of the respective one of the secondary through passage pipes 166, 168. The one or more lobes 186, 188 disrupt the large-scale turbulent eddies along the respective one of the secondary through passage pipes 166, 168, and thereby alter the resonance that produce the unwanted tones.

The present invention has been found to significantly suppress resonant tones produced by large-scale turbulent eddies as encountered in muffler systems. The following examples present the results of acoustic spectra measurements.

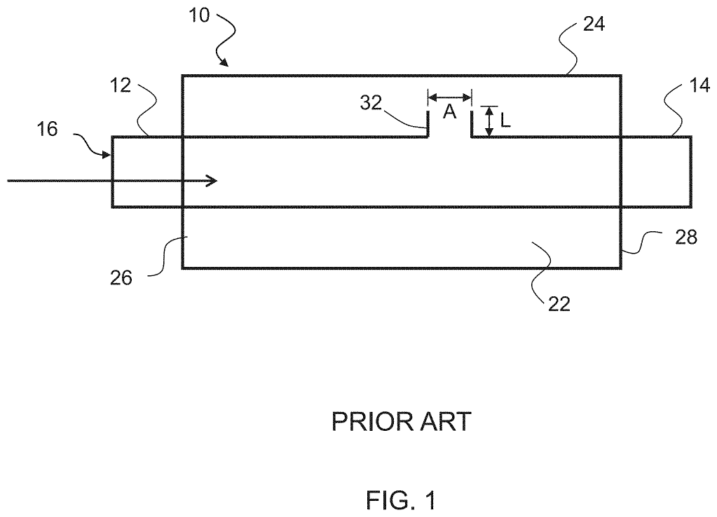

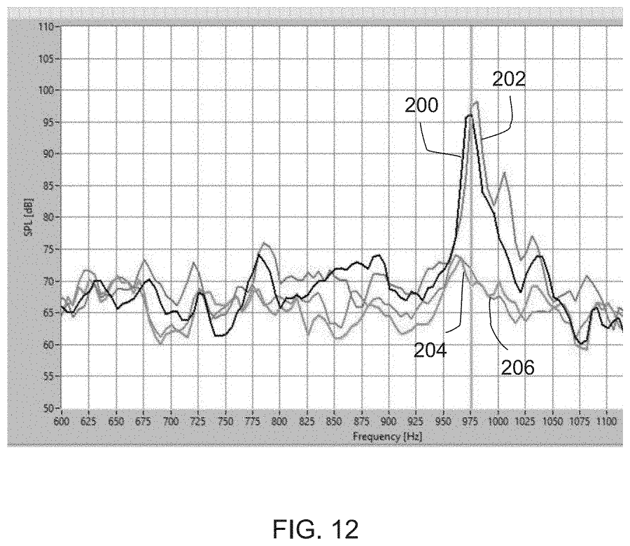

Example 1: for a Helmholtz resonator muffler 10, as depicted in FIG. 1, acoustic spectra were measured using a microphone placed at the outlet 14. The through passage pipe 16 was connected to an air flow source at the inlet 12. A maximum flow, designated 100% flow, was 750 cubic feet per minute. Tests were done over a range from 50% to 85% of maximum flow in increments of 5%. The acoustic spectrum resulting from these tests at flow rates of 75% and 80% of maximum flow are plotted in FIG. 12, which indicates sound pressure level (SPL) measured in decibels (dB) as a function of audible frequency in the acoustic spectrum from 600 Hertz (Hz) to 1100 Hz.

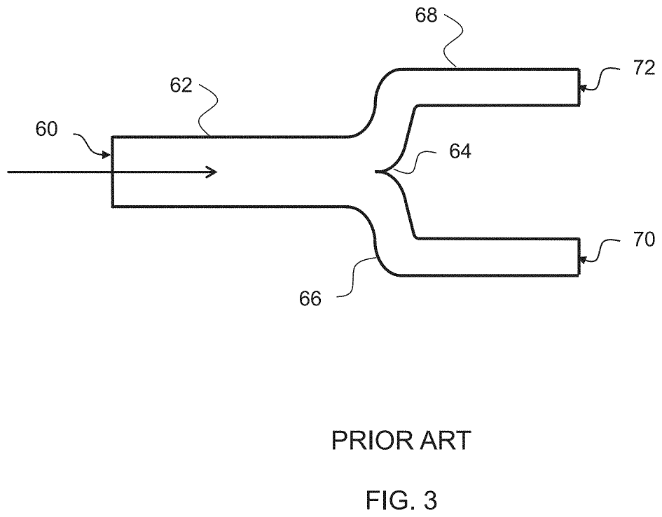

As shown in FIG. 12, a resonant tone was observed as a sound pressure peak at a frequency of 976 Hz for a plot 200 representing a flow rate of 75% of maximum flow. A similar resonant tone was also observed as a sound pressure peak at a frequency of 976 Hz on a plot 202 presenting a flow rate of 80% of maximum flow, as also shown in FIG. 12. The tests were repeated using a Helmholtz resonant muffler 110 as described in FIG. 3, employing a flow modification component in the form of a porous plate 134 including slots 140 as depicted in FIG. 5. For a flow rate of 75% of maximum flow, a reduction of 25 dB was observed for the resonant tone at a frequency of 976 Hz as shown in the plot 204 of FIG. 12. For a flow rate of 80% of maximum flow, a reduction of 25 dB was observed for the resonant tone at a frequency of 976 Hz as shown in the plot 206 of FIG. 12.

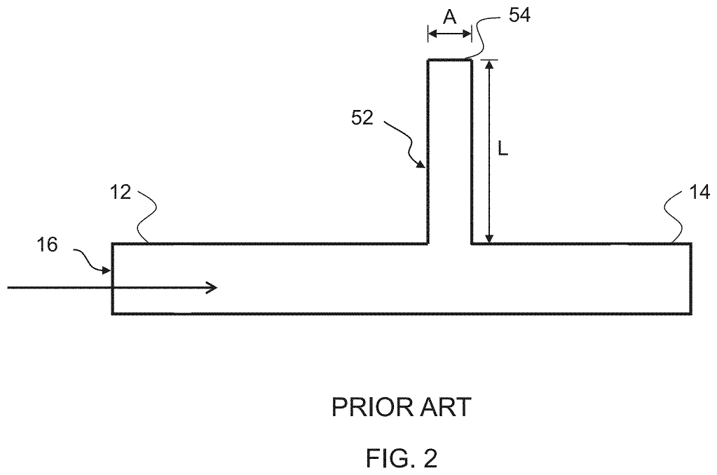

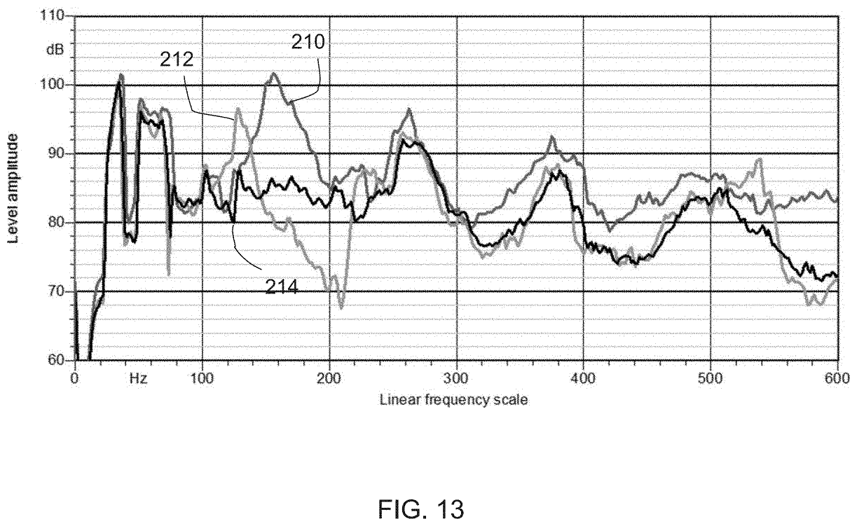

Example 2: for the side branch resonator muffler depicted in FIG. 2, acoustic spectra were measured using a microphone place at the outlet 14. The through passage pipe 16 was connected to a combustion gas source at the inlet 12. Tests were performed for three configurations: 1) employing just the through passage pipe 16; 2) employing a side branch passage 52; and 3) a side branch resonator muffler in accordance with the embodiment of FIG. 7, including a flow modification component in the form of a dissipative material component 142. The results are shown in FIG. 13, where level amplitude is shown as a function of linear frequency from 0 Hz to 600 Hz.

Pipe resonant modes were measured for the case with only a through passage, as shown at plot 210 of FIG. 13, indicating an amplitude peak near 160 Hz. For the case employing a side branch passage, a side branch 52 having length L of 19 inches and a cross sectional area A of 4.45 square inches was inserted as described in FIG. 2. For this test case, as shown in the plot 212 of FIG. 13, the amplitude peak near 160 Hz was reduced, and other sound levels were reduced across a range of frequencies from 140 Hz to 220 Hz. However, the plot 212 negatively indicates a secondary resonant peak that occurs near 120 Hz resulting from the insertion of the side branch 52. The plot 214 shows the superior results obtained from the embodiment of the invention as shown in FIG. 7 including the addition of the flow modification component in the form of a dissipative material component 142 to the side branch resonator muffler. The plot 214 indicates that the secondary tone at 120 Hz is eliminated.

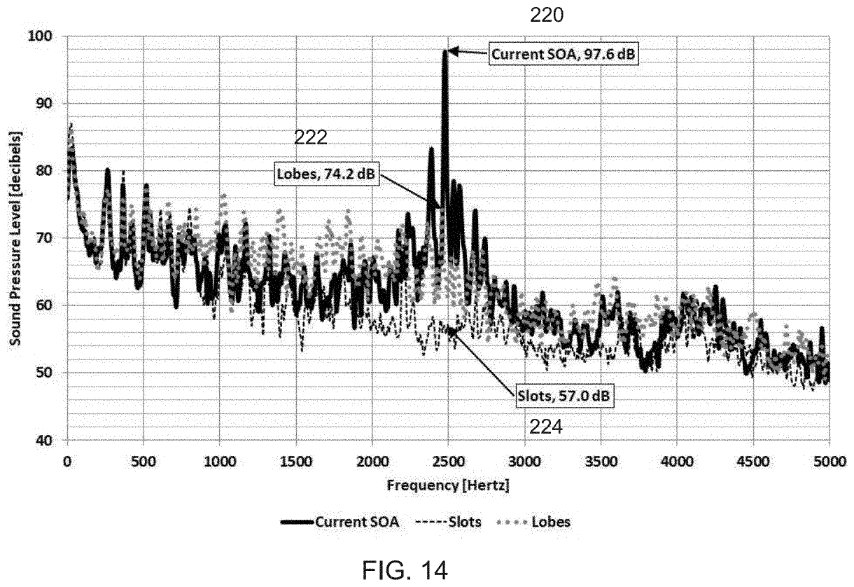

Example 3: further representative tone suppression from several embodiments of the invention are shown in the graph of FIG. 14. The plot shows the acoustic spectra of sound pressure level (SPL) measured in decibels (dB) as a function of audible frequency in the acoustic spectrum from 0 Hz to 5000 Hz, as measured near the exhaust pipe exit with and without flow modification devices.

As indicated in the first plot 220, a current state of the art (SOA) Helmholtz resonator muffler without a flow modification component exhibits a resonant tone of 97.6 dB at an audible frequency just under 2500 Hz. As indicated in the second plot 222, a Helmholtz resonator having a flow modification component in the form of a single lobe 186, as in the embodiment shown in FIG. 9, reduces the resonant tone to 74.2 dB. As indicated in the third plot 224, a Helmholtz resonator having a flow modification component in the form of a porous plate 134 with slots 140, as shown in the embodiment of FIG. 4, reduces the resonant tone to 57.0 dB.

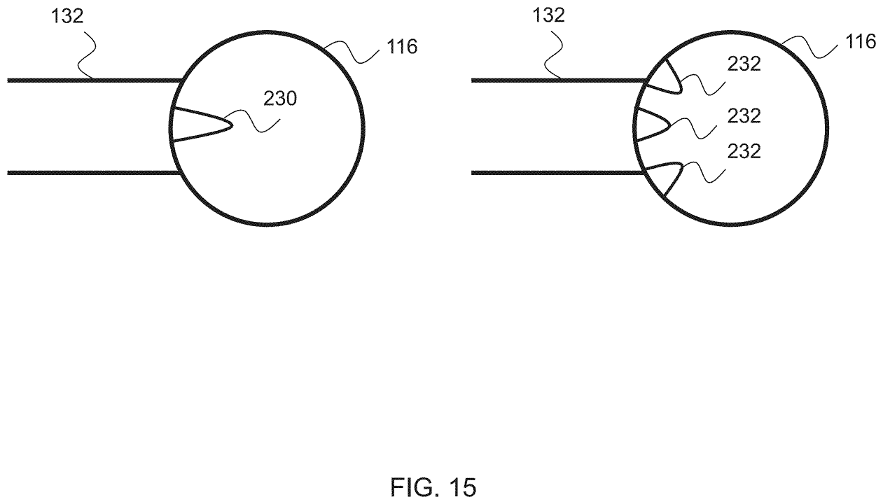

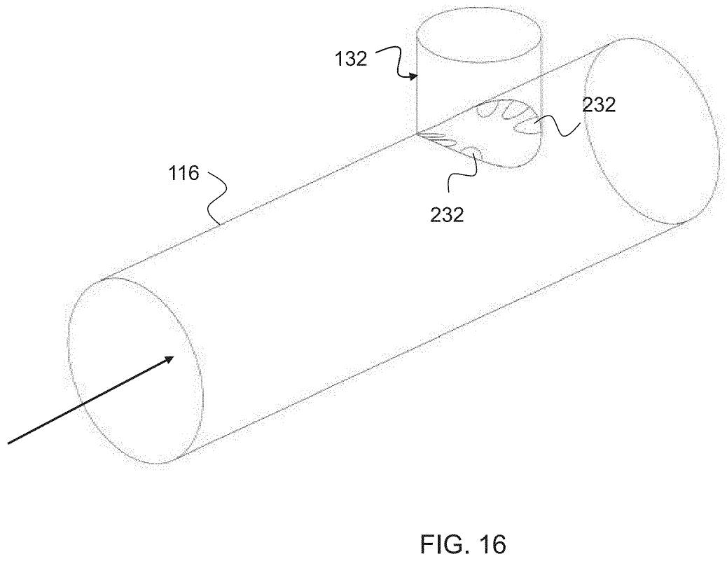

As further depicted in FIGS. 15 and 16, flow modification can generally be implemented on a small scale by any disruption in flow within the though passage pipe 116. However, such small scale disruptions do not sufficiently modify the flow and are thus not as effective at reducing undesirable resonant tones as the exemplary embodiments described hereinabove. These examples are presented herewith for the illustration of the general principles of noise suppression as discovered in the research and development by the present inventors.

FIG. 15 depicts embodiments of a Helmholtz resonator muffler having a flow modification component in the forms of protrusions 230 and chevrons 232 in accordance with additional alternative exemplary embodiments of the present invention FIG. 15 is a cross-sectional view taken along line A-A shown in FIG. 9 and includes an aperture pipe 132, as described in detail hereinabove.

In the embodiments shown in FIG. 15, a protrusion 230 can be formed on the through passage pipe 116 at a position located just upstream of the aperture tube 132, at a position proximate to the junction of the through passage pipe 116 and the aperture tube 132 and flush to the through passage pipe 116. The protrusion 230 can be a piece of metal welded to the interior of the through passage pipe 116, or can be a nail or screw driven through the wall of the through passage pipe 116 at the selected location. The protrusion 230 modifies the turbulent flow within the through passage pipe 116 to suppress tones.

Alternatively, as also shown in FIG. 15, flow modification can generally be implemented on a small scale by a series of chevrons 232 that can be formed circumferentially on the interior of the through passage pipe 116 at positions located just upstream of the aperture tube 132, at a position proximate to the junction of the through passage pipe 116 and the aperture tube 132. The chevrons 232 can be pieces of metal, generally triangular in shape, welded to the interior of the through passage pipe 116. The chevrons 232 modify the turbulent flow within the through passage pipe 116 to suppress tones. It is to be appreciated that similar results can be obtained by similarly adapting such a protrusion 230 or chevrons 232 in the aforementioned embodiments including a side branch passage 152 or a secondary through passage pipe 168.

In a further alternative embodiment, as shown in FIG. 16, flow modification can also be implemented on a small scale by a series of chevrons 232 that can be formed circumferentially on the interior of the aperture tube 132 at a position proximate to the junction of the through passage pipe 116 and the aperture tube 132. As with the aforementioned embodiment, the chevrons 232 can be pieces of metal, generally triangular in shape, welded to the interior of the through passage pipe 116. The chevrons 232 modify the turbulent flow at the opening of the aperture tube 132 adjoining the through passage pipe 116 to suppress tones.

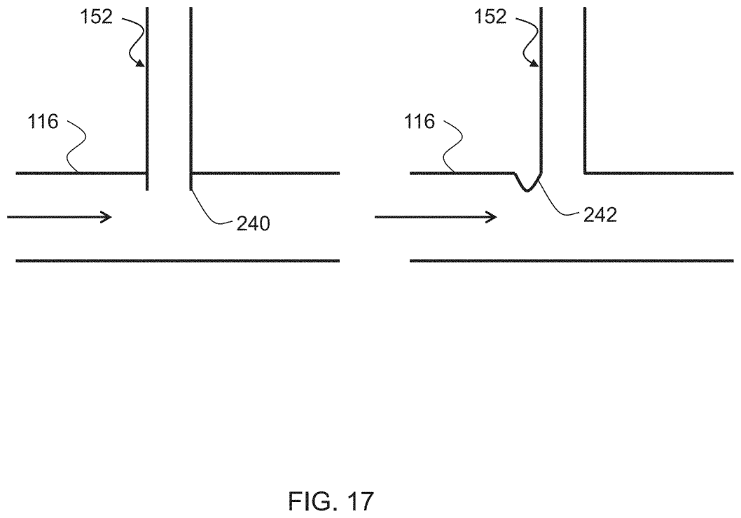

FIG. 17 is a side-sectional view of a muffler with a side branch resonator having a flow modification component in the form of various pipe modifications in accordance with additional exemplary embodiments of the present invention. In the embodiments shown in FIG. 17, the side branch passage 152 can include an extension 240 where the side branch passage 152 is made to extend inside the interior of the through passage pipe 116. The extension 240 modifies the turbulent flow within the through passage pipe 116 to suppress tones.

Alternatively, as also shown in FIG. 17, flow modification can generally be implemented on a small scale by an indentation 242 that can be formed circumferentially on the exterior of the through passage pipe 116 at a position located just upstream of the side branch passage 152, at a position proximate to the junction of the through passage pipe 116 and the side branch passage 152 and flush to the passage pipe 116. The indentation 242 can be formed by striking the through passage pipe 116 with a die to create a deformation that can modify the turbulent flow within the through passage pipe 116 to suppress tones. It is to be appreciated that similar results can be obtained by similarly adapting such an extension 240 or indentation 242 in the aforementioned embodiments including an aperture tube 132 or a secondary through passage pipe 168.

Numerous embodiments have been described herein. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

Having thus described the invention, it is now claimed:

1. A muffler comprising:
a through passage pipe comprising an inlet for admitting a flow of exhaust gases;
a diverging pipe that branches off from the through passage pipe;
a flow modification component incorporated into one of the diverging pipe or the through passage pipe at a position proximate to a junction of the through passage pipe and the diverging pipe, wherein the flow modification component comprises at least one structure having a screen pattern with a plurality of slits or slots that allows low frequency acoustic waves to pass through while reducing large-scale turbulent eddies that produce undesirable resonant tones to small-scale turbulent eddies, wherein the muffler is a Y-pipe muffler such that the through passage pipe is a primary through passage pipe that joins a pair of secondary through passage pipes at a split junction such that the diverging pipe comprises one of the secondary through passage pipes.

2. The muffler of claim 1, wherein the flow modification component is incorporated into an opening in the diverging pipe at a position proximate to the junction of the through passage pipe and the diverging pipe and flush to the through passage pipe.

3. The muffler of claim 2, wherein the at least one structure of the flow modification component comprises a porous plate having a screen pattern geometry in the form of a plurality of openings having sufficient porosity to allow the low frequency acoustic waves to pass through while reducing the large-scale turbulent eddies to the small-scale turbulent eddies that will not acoustically couple with acoustic resonant modes of the muffler.

4. The muffler of claim 3, wherein the screen pattern geometry of the porous plate comprises a predetermined size, shape, number, and spacing of the plurality of openings, wherein a frequency of sound from the small-scale turbulent eddies is determined by the screen pattern geometry.

5. (canceled)

6. The muffler of claim 3, wherein the screen pattern comprises a plurality of openings having at least 20% open porosity.

7. The muffler of claim 3, wherein the screen pattern comprises a plurality of openings having at least 60% open porosity.

8. The muffler of claim 2, wherein the at least one structure of the flow modification component further comprises a dissipative material component retained within an internal port passage of the diverging pipe tube to further reduce resonant tones of the muffler.

9. The muffler of claim 8, wherein the dissipative material component comprises loosely packed fiber material having a material density selected to allow low frequency acoustic sound waves to be transmitted while attenuating higher frequency sound waves.

10. The muffler of claim 9, wherein the dissipative material component is substantially transparent to low frequency sound waves below about 1000 Hz.

11. The muffler of claim 1, wherein the flow modification component is incorporated into the through passage pipe at a position proximate to the junction of the through passage pipe and the diverging pipe.

12. The muffler of claim 11, wherein the at least one structure of the flow modification component comprises at least one lobe incorporated into the through passage pipe at a position just upstream of the diverging pipe, at the position proximate to the junction of the through passage pipe and the diverging pipe.

13. The muffler of claim 11, wherein the at least one lobe comprises a penetration into the through passage pipe of less than 25% of the inside diameter of the through passage pipe.

14. The muffler of claim 1, wherein the through passage pipe further comprises an outlet such that the through passage pipe joins the inlet and the outlet.

15.-20. (canceled)
